(19) United States
(12) Patent Application Publication
(10) Pub. No.: US 2024/0223124 A1
(43) Pub. Date: Jul. 4, 2024

(54) SOLAR CONCENTRATOR ASSEMBLY

(71) Applicant: Raja Singh Tuli, Montreal (CA)

(72) Inventor: Raja Singh Tuli, Montreal (CA)

(21) Appl. No.: 18/403,123

(22) Filed: Jan. 3, 2024

Related U.S. Application Data
(60) Provisional application No. 63/437,058, filed on Jan. 4, 2023.

(51) Int. Cl. H02S 40/22; F01D 15/10; F22B 1/00; F24S 23/70; F24S 80/54; H02S 40/44

(52) U.S. Cl. CPC H02S 40/22; F01D 15/10; F22B 1/006; F24S 23/70; F24S 80/54; H02S 40/44

(57) ABSTRACT

The present invention provides a solar energy collecting and converting system comprising a plurality of segmented reflective elements such as mirrors forming a trough shape structure. These reflective elements are attached to the glass top of a metal box. The solar cells are placed at the bottom of the box and heat sinks are placed underneath the solar cells. Further, the segmented reflective mirrors are attached to a rod at the bottom for additional support. In a variation of the system, the solar cells are replaced with an insulated container comprising light absorbing material at the bottom of the panel. A glass window on the top of insulated container lets the solar light pass through and heat the light absorbing material. The small size of the window does not let the heat radiate from the insulated container through the window and improves the performance of the whole system.

### CROSS-REFERENCE TO RELATED APPLICATIONS

This application claims priority to U.S. provisional patent application No. 63/437,058, entitled “SOLAR CONCENTRATOR ASSEMBLY,” filed on Jan. 4, 2023. The content of this U.S. provisional patent application is hereby incorporated by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to systems that employ energy-converting units, such as photovoltaic cells, to harness solar energy. More particularly, the present invention pertains to a solar energy concentrating system where segmented solar concentrators are mounted on an assembly to create a fixed-focused type solar concentrator.

### Description of Related Art

Efforts to save the environment and search for a renewable source of energy have given rise to many advances in solar-electricity generation for both commercial and residential applications. Typically, photovoltaic (PV) solar cells are used in a solar panel to convert sunlight into electricity. When the sun shines onto a solar panel, energy from the sunlight is absorbed by the PV solar cells in the panel. These solar cells are typically made using square or quasi-square silicon wafers that are doped using established semiconductor fabrication techniques and absorb energy from sunlight. This energy creates electrical charges that move in response to an internal electric field in the cell, causing electricity to flow.

Generally, a large number of PV solar panel assemblies are mounted on an open field or on a surface of a building to receive sunlight irradiation and generate the power. In order to make PV modules receive better sunlight, a solar tracking system was implemented in some methods. The motion of the sun can be tracked in real-time, and the orientation of the solar panel is adjusted to receive the sunlight always perpendicular to the solar panel. In this way, the amount of solar radiation received by the solar panel can be maximized and hence the power generated by the solar system.

The typical solar concentrators can be classified according to several aspects. The ones relevant for the purpose of the present description are the kind of focusing employed (point, line or area), positional adjustability of the reflectors involved in the concentration process (fixed or tracking devices) and characteristics of the conversion systems—solar panels, heat absorbers, or both.

Compared to non-concentrating solar energy conversion systems, the sunlight concentrated toward a photovoltaic solar panel is magnified. As a result, on the one hand, solar energy concentrator systems benefit more than non-concentrating solar energy systems from using relatively more performing solar panels. Efficiency improvements are fast in the field of photovoltaic solar cells, and solar energy concentrator systems thus benefit particularly from an easy upgrade to a more efficient solar panel. On the other hand, more heat is gathered at the target area of a concentrator system than in a non-concentrating solar energy system. Heat negatively affects the efficiency of photovoltaic solar panels, entailing that efficient heat transfer or cooling systems have a special importance in solar energy concentrator systems that rely on photovoltaic solar panels as their receivers.

Several examples of solar energy concentrators are found in the prior art. These apparatuses feature several inconveniences, such as complexity and cost. Furthermore, many of those designs do not easily lend themselves to installation in the scale contemplated for supplying a household. For example, the structural weight and design of even a small-sized, movable dish reflector complicates its deployment atop a house roof, in addition to making it vulnerable to wind damage. Sidestepping these problems by reducing the scale of the dish reflector seriously limits the amount of energy this kind of concentrator may yield.

Based on the end application, different types of solar concentrators are employed to achieve optimum results. In the specific scope of the present invention—continual collection of concentrated solar radiation reflected to a focal area in order to generate energy for supplying a standard household or small real estate unit—the performance of state of the art solar concentrators is suboptimal, or the system is too expensive or complex for use by a standard household or in a small real estate unit.

In methods described in U.S. Pat. No. 6,971,756 B2 and U.S. Pat. App. No. 20030137754 A1, the concentrator have an array of slat-like concave reflective elements and an elongated receiver for receiving the concentrated sunlight. The mirrored surfaces of reflective elements provides individual profiles represented by curved and/or straight lines are positioned so that the energy portions reflected from individual surfaces are directed, focused, and superimposed on one another to cooperatively form a common focal region on the receiver. The mirrored surfaces are inclined towards one another at their rear ends facing the receiver and can be arranged to provide lens-like operation of the array. The receiver can be arranged in line photovoltaic cells or a tubular solar heat absorber. However, the structure of the concentrator is very big for practical implementation and any change in profile of a single reflective surface could imbalance the whole concentrator arrangement or reduce the efficiency significantly.

Some of the other systems use segmented mirrors like solar concentrators or parabolic trough-shaped structures concentrators for concentrating the sunlight on a pipe. The pipe carries the water to heat and consequently generates the steam to run a turbine for generating electricity. However, in such systems, the collected energy could radiate during the night and the system could not preserve the energy collected during the daytime.

Another alternate method in the prior art uses parabolic mirrors to focus solar rays around a vacuum tube carrying a fluid or material for heating and storing energy. However, this method is inefficient in storing heat energy for a longer period of time because the heat could radiate in all directions during the night time.

All these above-mentioned existing approaches do not take into account the size and efficiency of the solar power generation system to collect solar power and generate electricity through different methods.

There is accordingly a need for an improved solar concentrating system that overcomes the limitations associated with using complex or suboptimal structures or assemblies that require a high degree of skills. Moreover, there is a need for an efficient solar concentrating system wherein the costs associated with manufacture and deployment, which are prohibitive with respect to traditional solar concentrating systems, are minimized so that it is affordable and attractive for use by small- and medium-scale household use.

It is therefore an object of the present invention to disclose a small- or medium-scale, dimensionally-adaptable solar concentrator system featuring high energy conversion efficiency, providing area focus with low building and operational costs.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to a fixed-focused segmented parabolic type solar concentrator assembly. Multiple solar panels are arranged in arrays of rows, wherein each row has multiple solar panels. Each of the solar panels has multiple reflecting concave mirror concentrators forming trough structure. Further, each one of the reflecting mirror concentrators receive sunlight and reflects them on to a high efficiency solar cell. The high efficiency solar cell is an array of serially connected solar cell units. The length of the high efficiency solar cell is nearly same as that of the paired mirror concentrators. Each high efficiency solar cell is positioned at the bottom of the panel in such a way that it receives maximum amount of reflected sunrays throughout the year. The position of the solar cells should be such that they remain near the focus so that the solar cell can receive most of the sunrays reflected by the mirror concentrators. Each of the solar energy panels has a glass top that allows sunrays to pass through it and hit the paired mirror concentrators.

In a preferred embodiment of the present invention, a solar energy system comprises a solar panel for collecting and converting solar energy. The solar panel includes segmented solar energy concentrators comprising a plurality of concave reflective elements having parallel longitudinal axes, and solar cells extending parallel to segmented solar energy concentrators. The concave reflective elements of segmented solar energy concentrators are arranged in a way the elements are spaced apart and positioned adjacent and facing each other in a paired arrangement.

In a preferred embodiment of the present invention, the reflective elements are attached to the top glass with an adhesive and a rod. In another embodiment of the invention, an extra pair of side mirrors is attached with a shaped rod to further improve the efficiency of the whole system.

In an alternate embodiment of the invention, an insulated container or black body is provided in place of the solar cell. The black body contains any suitable material such as sand, black sand, salt, oil, metal, etc. that could heat up quickly and further heat water running inside an elongated pipe disposed longitudinally inside the insulated container. The heated water can then be used for generating steam to operate a small turbine and generate electricity.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective view of a solar energy system in accordance with the subject disclosure.

FIG. 2 is a perspective view of the arrangement of the support rod in the solar panel.

FIG. 3 is a perspective view of the arrangement of the support structure in the solar panel.

FIG. 4 is a perspective view of a solar energy system in accordance with the preferred embodiment.

FIG. 5 is a perspective view of the solar energy system in accordance with an alternate embodiment.

FIG. 6 illustrates the operation of a solar panel in accordance with the subject disclosure.

FIG. 7 shows a schematic illustration of forming high efficiency solar cells in accordance with the subject disclosure.

### DETAILED DESCRIPTION

The subject disclosure is directed to a solar energy concentrating system where trough-shaped solar concentrators are mounted on an assembly and the whole assembly moves on an axis to track the Sun for achieving maximum solar radiation to the solar cells.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The invention relates to a fixed-focused segmented parabolic type solar concentrator assembly. Multiple solar panels are arranged in arrays of rows, wherein each row has multiple solar panels. Each of the solar panels has multiple reflecting concave mirror concentrators forming trough structure. In preferred embodiment, each solar panel is constructed to form a metal box shape structure with glass on the top. Further, each one of the reflecting mirror concentrators receive sunlight and reflects them on to a high efficiency solar cell. The high efficiency solar cell is an array of serially connected solar cell units. The length of the high efficiency solar cell may be the same as that of the paired mirror concentrators or the length of the metal box. Each high efficiency solar cell is positioned at the bottom of the panel in such a way that it receives maximum amount of reflected sunrays throughout the year. The position of the solar cells should be such that they remain near the focus so that the solar cell can receive most of the sunrays reflected by the mirror concentrators. Each of the solar energy panels has a glass top that allows sunrays to pass through it and hit the paired mirror concentrators. Further, with the mentioned arrangement of solar concentrator mirrors, the concentrated solar rays are spread across and incident evenly on the solar cells. So the solar concentrator avoids heating solar cells unevenly on particular points. When multiple panels are kept in a row, each of the high efficiency solar cells is connected in series to its corresponding high efficiency solar cell present in its adjacent panel in the same row. Thus, a single row of panels has two rows of serially connected high efficiency solar cells. In an alternate arrangement, all rows within a panel are connected in series with others and further connected to the next panel in series. When multiple rows of panels are present, it creates twice the number of serially connected solar cells than the number of rows of the panels. All the serially connected solar cells are then connected to each other as per parallel connection.

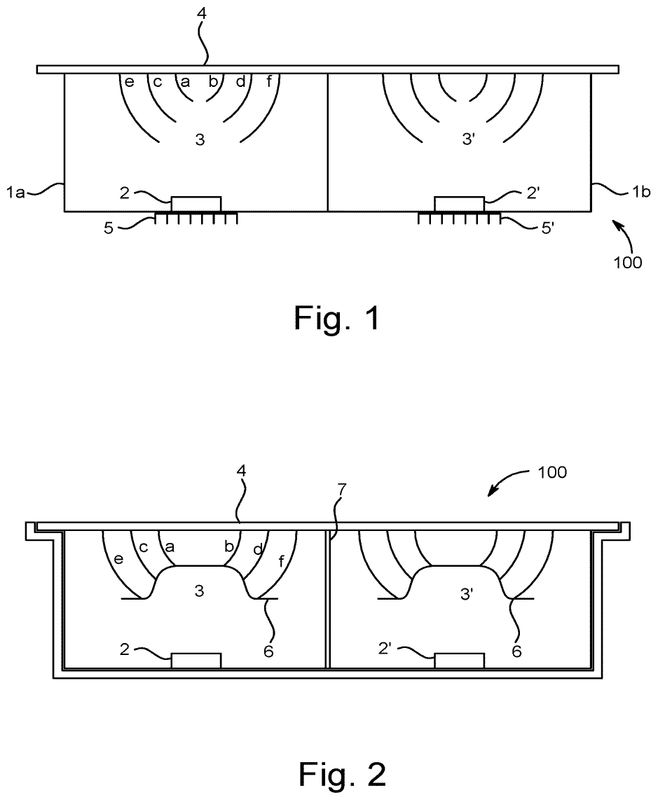

Now referring to the drawings and particularly to FIG. 1 to FIG. 5, various features of the subject disclosure are now described in more detail with respect to a solar energy generating system 100.

FIG. 1 is a perspective view of an embodiment of the solar energy generating system 100 having multiple solar panels 1 where each solar panel contains multiple rows of troughs. Also, it must be noted that the solar panels 1 are also referred as panels throughout the detail description of the invention. For the sake of understanding only, two rows of panels 1 are shown having only two solar concentrators 1a and 1b in each row. However, multiple individual solar concentrators 1 (1a and 1b) can be placed adjacent to each other in a row and multiple such rows can be present in the solar energy generating system 100. Each one of the solar panels 1 has two reflecting concave mirror concentrators 3 and 3′ that reflect sunrays to two solar cells 2 and 2′. The solar cells 2 and 2′ are high efficiency solar cells. Further, the upper end of all reflecting concave mirror concentrators 3 and 3′ are attached to the glass top 4 with an adhesive. In one embodiment, the bottom ends of all the mirrors for each row of solar cells are connected together with a support structure 6 such as a metal strip or rod.

In the preferred embodiment of the present invention, FIG. 1 describes a solar energy system 100 which comprises a solar panel 1 for collecting and converting solar energy. The solar panel 1 includes segmented solar energy concentrators 3 comprising a plurality of concave reflective elements 3a-3f having parallel longitudinal axes, and solar cells 2 extending parallel to segmented solar energy concentrators 3. In an alternate embodiment, the reflective elements 3a-3f may be segmented straight mirrors forming an overall concave trough shape structure. The concave reflective elements such as mirrors 3a-3f of segmented solar energy concentrators 3 are arranged in a way the elements 3a-3f are spaced apart and positioned adjacent and facing each other in a paired arrangement.

In the preferred embodiment of the invention, the solar panel 1 is constructed with a standard size 2 meter×1 meter panel. The standard size panel may comprise 3 or 4 rows of multiple paired concave mirrors, six (3 pairs), for example, in a preferred embodiment of the invention. The height of the solar panel is 5 inches and is covered with a thick piece of glass top 4. The multiple paired concave mirror elements 3a-3f are attached to the glass top 4 with an adhesive. The purpose of utilizing multiple sets of paired concave mirrors is to keep the height of the panel as minimum as possible and achieve the maximum concentration. With this disclosed arrangement of 5 inches height solar panel, we achieved 15 times more solar concentration in comparison to the basic arrangements.

FIG. 2 demonstrates a perspective view of the arrangement of the support rod 6 in the solar panel. The upper ends of all reflecting elements 3a-3f are attached to the glass top 4 with an adhesive. The bottom ends of all the reflecting elements for each row of solar cells are connected together with multiple shaped metal rods 6 distributed equally throughout the panel. In an embodiment, the metal rods 6 are placed uniformly approximately 6 inches apart. The metal rods 6 connect the reflecting elements together in a way that provides additional support to the reflecting elements. In another embodiment, metal rod 6 can also be connected to the side walls of the solar panel box for providing additional support when required. In another embodiment, a support column 7 can also be provided for extra support to the glass top 4. It should be understood that the support column 7 can be a continuous sheet placed vertically or one or more support columns 7 distributed uniformly.

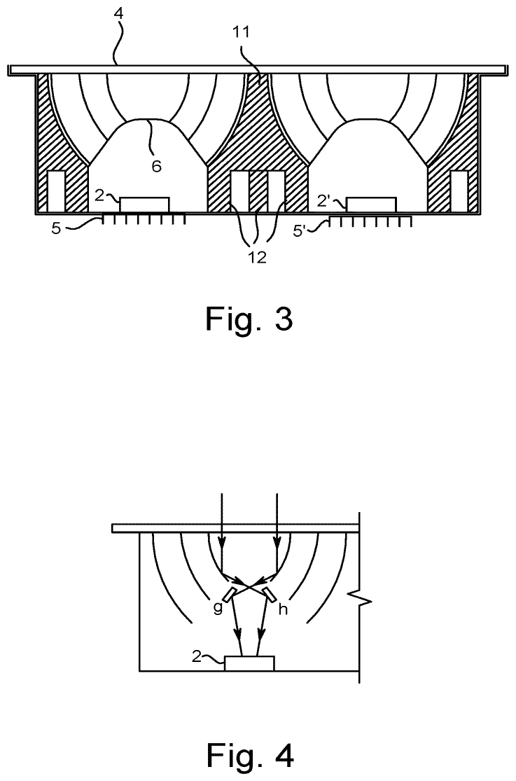

In another embodiment, the additional support to the top glass is provided by placing a support structure 11 as depicted in FIG. 3. The support structure 11 can also support the last piece of the reflective elements 3a and 3f. It should be understood that, in some embodiments, the support structure 11 can be a continuous structure along the reflective mirrors. In some embodiments, the distal ends of the support rod 6 can be attached to the support structure 11 at the opposite ends. In another embodiment, the support structure 11 can be evenly distributed at 6 inches apart along the mirror such that the distal ends of the support rod 6 can be attached to the support structures 11. In some embodiments legs 12 of the support structures 11 are made with flexible material to avoid any misalignment of the reflective elements due to bending or bowing of the glass top 4 or panel box 1.

In the preferred embodiment of the invention, all the reflecting mirrors (3a-3f) are attached to the glass top 4 with an adhesive at the top and with the rod 6 at the bottom. The bottom ends of the mirrors are connected with the shaped rods 6 distributed uniformly at about 6 inches distance to provide additional support. Since the solar cell wafers are cut in 18 mm width and 6″ in length, the rods connecting the mirrors are spaced apart every 6 inches because of the size of the solar cell underneath. The shadow of the rods connecting the mirrors together should fall equally on each solar cell and reduce the efficiency of the solar cells equally. Since the current flows from one cell to another through the least efficient cell, if one solar cell has less efficiency, all the solar cells have less efficiency. In a preferred embodiment, the support rods are arranged such that a solar cell has the shadow of at most one support rod falling on it at any instance of time.

The solar cells 2 and 2′ are disposed in the focal region cooperatively formed by pair of reflecting mirrors 3a-3f and have heat sinks 5 and 5′ underneath. The heat sinks 5 and 5′ are placed underneath the metal box and can dissipate the heat to cool down the solar cells. The solar cells 2 and 2′ intercept and convert the concentrated solar energy to electricity. In another embodiment, the solar cells 2 and 2′ can be replaced with any suitable solar energy receiver such as sand or other material by a person skilled in the art.

In another embodiment, FIG. 4 describes an extra pair of side mirrors 3g and 3h for focusing solar rays to the solar cell 2. The alternate arrangement further improves the efficiency of the whole system in a manner that the side mirrors 3g and 3h reflect the solar rays from the opposing mirrors and redirect the rays to the solar cells that would be otherwise lost. All reflective elements 3a-3f and side mirrors 3g-3h are arranged in such a manner that solar light is focused and evenly distributed on the solar cells and consequently avoids too much heating the solar cells at certain portions.

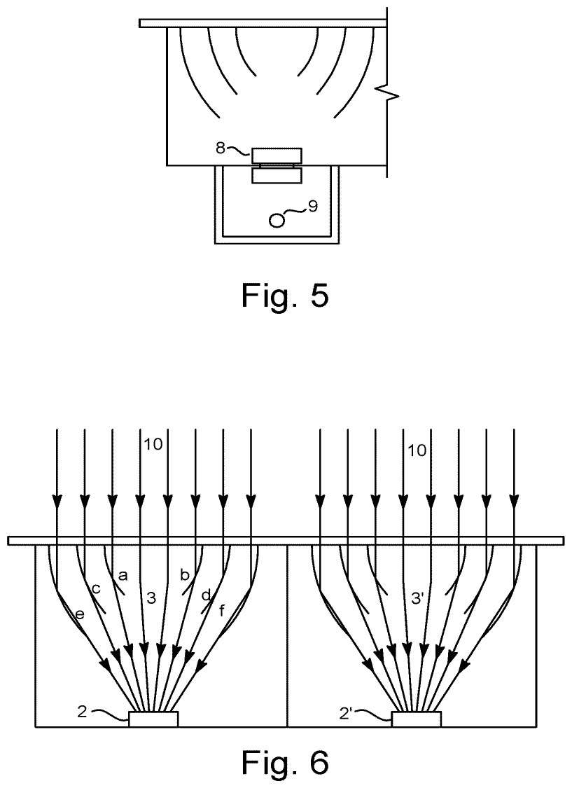

In an alternate embodiment shown in FIG. 5, the solar cell 2 is replaced with an insulated container comprising black light absorbing material at the bottom of the panel. In place of the solar cell 2, there is provided glass window 8 at the bottom portion of the metal box. In a preferred embodiment, the glass window 8 can include a first glass element and a second glass element. The first glass element and the second glass elements are separated by trapped air or vacuum between the two glass elements for creating an insulated glass window 8. The trapped air or vacuum between the two glass elements significantly reduces the rate of heat loss through the glass window 8 by conduction and convection. The glass window 8 is arranged in such a manner that the concentrated solar light is incident on the glass window 8 from the top. The light travels through the window 8 to the insulated container and heats the black light absorbing material in the insulated container underneath. Due to the insulated nature of the glass window 8, the system does not radiate heat outward through the glass window. Additionally, the size of the glass window 8 is kept comparatively small to the bottom area of the metal box so that the insulated container does not radiate energy through the glass window 8. The insulated container may contain any suitable light absorbing material such as sand, black sand, salt, oil, metal etc. that can heat up quickly and store heat. The light absorbing material inside the insulated container absorbs the heat in the daytime and the insulated container can retain the heat for longer period of time. In a preferred embodiment, an elongated pipe 9 containing water passes through the insulated container. The water inside the pipe heats up and generates steam which can then pass through a turbine to generate electricity.

FIG. 6 more fully illustrates the operation of solar panel 1 as a solar collector. Only three adjacent paired elements 3 are shown in FIG. 5 for the purpose of clarity. However, it should be understood that the solar panel 1 can incorporate any convenient number of reflective elements 3. Referring to FIG. 5, sunlight 15 (represented by parallel dotted lines) strikes reflective elements 3 and is reflected by mirrors 3a-3f to solar cell 2. As shown in FIG. 5, individual size, slope and curvature of each mirrored surface 3a-3f are selected and adjusted so that all sunlight 10 is efficiently concentrated to solar cell 2.

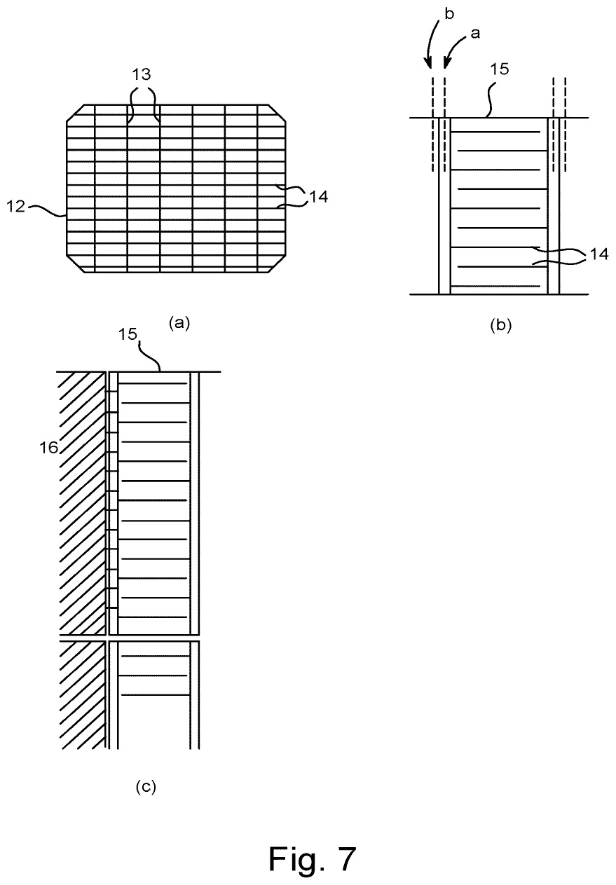

FIG. 7a shows a conventional solar cell 12. The most common solar cells are made of silicon wafers and solar conductors on the top to conduct the electrons. As shown in FIG. 7a, the silicon solar cells are metalized with thin rectangular-shaped lines 13 called busbars printed on the front and back sides of the solar cell 12. The busbars 13 conduct the direct current generated by the solar cells to other extremes. Typically, the busbars are constructed from copper, coated with silver. In a typical solar cell, multiple metallic and thinner grid lines are called solar cell fingers 14. The solar cell fingers 14 are perpendicular to the busbars 13. The solar cell fingers collect the generated current for delivery to the busbars. The busbars 13 carry the current generated by the cell fingers to the end and are joined together to one or more electrodes. On the back side of solar cells, additional busbars carrying the opposite current form a positive-negative arrangement for the current supply. While using conventional solar cells to collect concentrated solar light, the current produced by the solar cells is very high. The busbars and cell fingers in a conventional solar cell are not designed to carry the current generated by the concentrated solar light. Therefore, due to high resistance, the current loss from the busbars and cell fingers in a conventional solar cell is significant.

In an embodiment of the invention shown in FIG. 7b, a solar cell is cut vertically into or produced in smaller solar strips 15. The busbars 13, cell fingers 14 and cut lines ‘a’ and ‘b’ are shown in FIG. 7b. The solar cells are cut around the busbars in such a manner that the current from alternating cell fingers 14 is transferred through opposing busbars and minimize the current loss on the cell fingers. In preferred embodiments, the busbars of a solar strip 15 are cut at the centre. In some embodiments, as shown in FIG. 7c, when the busbars are not strong enough to carry the current, conductors can be utilized on the busbars. In some embodiments, the busbars are connected to the conductors using multiple connections. In another embodiment, the thickness of the busbars can also be increased through silkscreen printing, epoxy coding, and metallization. Additionally, losses can further be reduced by leveraging additional conductors 16. The additional conductors 16 are connected to the busbars 13 using multiple connections between busbars and conductors through various methods like continuous or scattered connections. The additional conductors 16 on both sides of the solar cell strip 15 can carry the current to the electrodes.

In the preferred embodiment of the invention, regular solar cells can be utilized to create high efficiency solar cells for generating current through concentrated solar light. Further, the high efficiency solar cells can be created by cutting the regular solar cells into strips in the very specific way described supra. The high efficiency solar cells created utilizing the aforementioned method are used in solar panel 1 described in the primary embodiment of the invention.

The detailed description provided above in connection with the appended drawings is intended as a description of examples and is not intended to represent the only forms in which the present examples can be constructed or utilized. It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A system for collecting and converting solar energy, comprising:
a box with a glass top,
one or more solar cells, and
one or more segmented reflective elements forming a trough shape concentrate solar light on the said solar cells, and
one or more additional pairs of reflective mirrors reflecting the solar light from the segmented reflective elements to the said solar cells.

2. The system according to claim 1, wherein the segmented reflective elements are attached to the glass top of the box.

3. The system according to claim 1, wherein one or more segmented reflective elements are attached to one or more support structures at the bottom for additional support.

4. The system according to claim 4, wherein one or more support structures are periodic in nature.

5. The system according to claim 5, wherein the periodicity of one or more support structures is similar or multiple of periodicity of the solar cells.

6. The system according to claim 1, wherein one or more support structures are connected to a vertical support structure placed outside of the last reflective element, wherein the vertical support structure is attached from bottom to the glass top.

7. The system according to claim 1, wherein the said box is made of metal.

8. The system according to claim 1, wherein the said solar cells are placed at the bottom of the box.

9. The system according to claim 1, wherein one or more heat sinks are placed underneath at least one of the said box.

10. The system according to claim 1, wherein one or more segmented reflective elements are plane mirrors.

11. The system according to claim 1, wherein one or more segmented reflective elements are concave mirrors.

12. The system according to claim 11, wherein one or more rods supporting said reflective elements are distributed evenly so that shadow of the rods on the solar cells does not impact the performance of the system.

13. The system according to claim 1, wherein the segmented reflective elements reflect and focus solar rays evenly on the solar cell to avoid heating the solar cells on particular portions.

14. A system for collecting and converting solar energy, comprising:
a box with a glass top,
a window at the bottom of the box,
one or more segmented reflective elements forming a trough shape,
an insulated container arranged below the said window, and
one or more additional pairs of reflective mirrors reflecting solar light from the segmented reflective elements to the said window.

15. The system according to claim 14, wherein the said insulated container contains a suitable heat absorbing material for absorbing heat.

16. The system according to claim 14, wherein the said insulated container contains an elongated pipe passing through the insulated container, wherein water flowing through the pipe heats up and generates steam.

17. The system according to claim 16, wherein a turbine can generate electricity after passing the steam through the turbine.

18. The system according to claim 14, wherein the segmented reflective elements concentrate the solar energy on the said window to heat the heat absorbing material in the said insulated container.

19. The system according to claim 14, wherein the size of the window is kept comparatively smaller than the width of the box to minimize the heat loss through the window.

20. The system according to claim 14, wherein the said window is made by placing two glasses one top of another and creating vacuum between the two glasses to create insulation.

21. The system according to claim 14, wherein the said box is made of metal.

22. The system according to claim 14, wherein one or more segmented reflective elements are plane mirrors.

23. The system according to claim 14, wherein one or more segmented reflective elements are concave mirrors.

24. The system according to claim 14, wherein one or more segmented reflective elements are attached to one or more rods at the bottom for additional support.
